(19) United States
(12) Patent Application Publication
(10) Pub. No.: US 2014/0095198 A1
(43) Pub. Date: Apr. 3, 2014

(54) LOCALIZATION OF A BRAIN NETWORK ASSOCIATED WITH SUSTAINED CHRONIC PAIN

(71) Applicant: R. Christopher Decharms, Montara, CA (US)

(72) Inventor: R. Christopher Decharms, Montara, CA (US)

(21) Appl. No.: 13/878,192

(22) PCT Filed: Oct. 7, 2011
(86) PCT No.: PCT/US11/55408

§ 371 Date: Nov. 18, 2013

Related U.S. Application Data
(60) Provisional application No. 61/404,807, filed on Oct. 7, 2010.

(51) Int. Cl. G06F 19/00

(52) U.S. Cl. CPC G06F 19/322
USPC 705/3

(57) ABSTRACT

The present invention provides a method for understanding the brain mechanisms of chronic pain. In some aspects chronic pain patients are asked to elevate their pain severity through tensing the muscles of their pain site during fMRI scanning. Areas Are within the brain are activated when patients increase pain, and both reported pain and the temporal activation pattern of these brain regions are sustained following the termination of the tensing task, simulating patients' experience in daily life. Identifying regions where activation time courses mimic a patient's pain report provides a new means of localizing chronic pain mechanisms within the brain. Functional magnetic resonance imaging (fMRI) data using a novel task that engages patients' own chronic pain experience is used for chronic pain diagnostics and classification. Methods of using these data to diagnose and treat chronic pain are further disclosed.

This application claims priority from US provisional application 61/404,807 filed on Oct. 7, 2010, the entire contents of which are incorporated by reference.

### STATEMENT AS TO FEDERALLY SPONSORED RESEARCH

This invention was made with government support under NIH grant #R44NS050642. The US government has certain rights in the invention.

### BACKGROUND OF THE INVENTION

### Introduction

Chronic pain represents a major public health issue, affecting over 20% of the population in a lifetime (Gureje et al., 1998), with 40% never receiving adequate treatment (Breivik et al., 2006), imposing a tremendous cost on society and the individual (Katz, 2002). Neuroimaging has provided the ability to localize the neural network responsible for producing experimentally-induced pain. The focus on experimentally-induced pain has been in part due to uncertainty about what tasks might be used for imaging chronic pain.

Neuroimaging has improved the appreciation for the interaction of cognitive, affective and sensory elements in chronic pain (Tracey and Mantyh, 2007). Over a decade has passed since the pain “neuromatrix” was first described (Melzack, 1999), and altered function in this network during nociception in fibromyalgia patients was reported soon after (Gracely et al., 2002). The pursuit of a mechanistic underpinning for chronic pain is especially important in functional somatic syndromes, where no peripheral pathology is apparent (Henningsen et al., 2007). Evidence suggests that dysfunction within brain regions now called the pain matrix (Jones et al., 2003) may underlie the transition from acute to chronic pain, clinically defined as pain lasting more than three months, as well as mediating its persistence. Reduced gray-matter density in several of these regions appears common across multiple chronic pain conditions (May, 2008). Augmented fMRI activation to an innocuous stimulus has been reported in chronic back pain (CBP)(Giesecke et al., 2004), while functional alteration of representational fields has been observed in phantom pain, chronic regional pain syndrome, and CBP(Flor et al., 2001; Maihofner et al., 2003). Altered neurochemistry has been identified, including reduced mu-opioid receptor availability in fibromyalgia (Harris et al., 2007), and reductions in N-acetyl aspartate and glucose in CBP (Grachev et al., 2000). The pain matrix has been separated into a lateral component, mediating sensory or discriminative aspects of pain, and a medial component mediating affective or emotional aspects (Albe-Fessard et al., 1985). In a recent meta-analysis of human neuroimaging data, Apkarian et al define a set of brain regions most commonly found to be active in acute pain, identifying somatosensory, limbic, thalamic, and prefrontal regions (2005).

Neuroimaging also provides a tool for assessing endogenous modulation of pain. Engaging a patient's own chronic pain could yield new insights, as the use of experimentally-induced noxious peripheral stimuli may engage different mechanisms than chronic disorders that may be mediated through central mechanisms (Apkarian et al., 2005). A recent report contrasted spontaneous pain fluctuations with applied thermal stimulation in CBP patients and identified distinct patterns of fMRI activation associated with each (Baliki et al., 2006).

Previous examinations of the temporal components of nociception using experimental stimuli have found evidence for prolonged or “late-phase” activation following pain application, compared against innocuous stimuli. In healthy subjects, heat pain but not warmth evoked a prolonged activation response, especially in primary sensory cortex (Moulton et al., 2005). Noxious mechanical stimulation similarly evoked prolonged signal changes when compared against non-noxious stimulation, most notably in the ACC and anterior insula (Lui et al., 2008). Activity in the ACC and insula has also been found to temporally correlate with pain perception in a somatic experimental pain challenge, where brain activation and pain ratings were elevated even twenty minutes after an injection of ascorbic acid into the foot (Porro et al., 1998; Porro et al., 2004). As noted in the latter reports, activity in these regions is also apparent during the anticipation of pain, suggesting their involvement in broader emotional or cognitive aspects of the pain experience. The sensory coding of pain and the evaluation of its intensity appear to activate overlapping neural circuitry, again including ACC and insula, as recently revealed in healthy subjects during thermal pain(Kong et al., 2006).

### SUMMARY OF THE INVENTION

The present invention provides a method for understanding the brain mechanisms of chronic pain.

In some aspects chronic pain patients are asked to elevate their pain severity through tensing the muscles of their pain site during fMRI scanning Areas within the brain are activated when patients increase pain, and both reported pain and the temporal activation pattern of these brain regions are sustained following the termination of the tensing task, simulating patients' experience in daily life. Identifying regions where activation time courses mimic a patient's pain report provides a new means of localizing chronic pain mechanisms within the brain. Functional magnetic resonance imaging (fMRI) data using a novel task that engages patients' own chronic pain experience is used for chronic pain diagnostics and classification. Methods of using these data to diagnose and treat chronic pain are further disclosed.

Generally the present invention identifies a network of brain regions involved in mediating chronic pain following physical manipulation of a patient's pain site, supporting central dysfunction mediating chronic pain. The novel task applied here allows robust and controllable modulations of the patient's endogenous chronic pain experience in both the presence and absence of an overt manipulation, and does not rely on acute, experimentally-induced pain stimuli. This removes an important confound in the study of chronic pain.

In some aspects the present invention provides methods for the identification of brain regions associated with chronic pain.

In some aspects the present invention provides methods for identifying patients who are suffering from chronic pain by performing fMRI and determining whether said patient has activity in brain regions associated with chronic pain.

In some aspects the present invention provides a method for determining whether an individual is misrepresenting the condition of chronic pain.

In some aspects the present invention provides a method for directing a therapy based upon whether a patient has activity in brain regions associated with chronic pain.

In some aspects the present invention provides methods for querying a database to determine whether a subject has a profile more similar to individuals with chronic pain or control individuals.

In some aspects an fMRI is performed while triggering pain in a region of chronic pain. In some aspect the pain is induced by the patient by flexing muscles near an area of chronic pain. In some aspect the fMRI is performed after a patient has triggered the chronic pain.

In some aspects the present invention provides a method comprising creating a database of fMRI patterns wherein the database comprises fMRI patterns obtained from individuals who suffer from chronic pain and wherein said individuals trigger said chronic pain by an overt act prior to or during the fMRI scan. In some embodiments the overt act is flexing muscles surrounding the site of the chronic pain.

In some aspects the present invention provides a method comprising statistically comparing a database of fMRI patterns obtained from individuals who suffer from chronic pain to the fMRI pattern of an individual suspected of having chronic pain to determine whether the individual exhibits and fMRI pattern indicative of chronic pain. In some embodiments the invention further involves determining whether a patient should be reimbursed for the treatment of chronic pain based upon the results of the comparison. In some embodiments the invention further involves determining whether a patient should be treated for chronic pain based upon the results of the comparison. In some embodiments the invention further involves determining whether a patient should reimbursed for treatment of chronic pain based upon the results of the comparison.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1: fMRI task design. A single fMRI scanning run included an initial 60 second Rest period, a 60 second Tense period during which patients tensed the muscles of their chronic pain site to deliberately increase pain, and a final two minute Sustained Pain period, during which subjects rested, but pain typically remained elevated. fMRI scanning runs alternated between continuous-rating and non-rating, where patients did or did not manipulate a two-button controller to provide online pain ratings. Approximately 5 runs of each rating type were performed in each scan session, and patients completed three sessions. Prior to fMRI scanning, patients were familiarized with the task, practiced tensing their pain site while keeping their head still, and completed the McGill Pain Questionnaire. Structural scans were acquired for coregistration and normalization purposes. See methods for details.

FIG. 2: Continuous pain ratings. During continuous-rating runs, patients provided online pain visual analog scale (VAS) ratings of their pain, excluding an initial baseline period. Ratings were between zero (no pain) and ten (worst pain imaginable). The plot shows the average pain VAS rating provided across all runs for all subjects, and error bars represent standard error (SEM). The fMRI scanning task periods are shown in the plot for comparison purposes; note the elevated pain ratings in both the tense period and the sustained pain period.

FIG. 3: Brain activation associated with tensing the chronic pain site: continuous pain ratings. A whole-brain GLM t-contrast between the tense pain site period and the initial rest period revealed brain activation in multiple regions of the “pain matrix” following FDR-correction for multiple comparisons. The data shown is from continuous-rating runs. Hot colors represent areas where brain activation is significantly greater during the tense condition (compared to initial rest), corresponding to the significance level shown in the color bar at right. Activation maps are overlaid on a template brain in Talairach atlas space, with axial slices of 4 mm thickness. Prominent areas of increased brain activation include the bilateral primary and secondary somatosensory cortices (first and second rows), dorsal ACC (left second row), left DLPFC (middle second row), bilateral posterior, medial and anterior insular cortex (left and middle third row), right thalamus (left third row) and right OFC (right third row). Images are displayed in radiological convention (left of the brain is shown on the right). Units are positive and negative t values.

FIG. 4: Brain activation associated with tensing the chronic pain site: no online pain ratings. In the absence of continuous pain ratings, a whole-brain GLM t-contrast between the tense pain site period and the initial rest period reveals similar areas of significant brain activation to those seen in FIG. 3, using the same analysis methods. As in the continuous-ratings case, prominent areas of increased brain activation in the absence of online ratings include the bilateral primary and secondary somatosensory cortices (first and second rows), dorsal ACC (left middle row), left DLPFC (middle second row), bilateral posterior, medial and anterior insular cortex (left and middle third row), and right thalamus (left third row).

FIG. 5: Brain activation time courses. Brain activation time courses for four areas of the brain demonstrating sustained activation following the tense pain site period and one region (L S1) not showing sustained activation are shown next to the spatial localization of each cluster. In each plot, the time course from runs without continuous ratings are shown in red. The time courses are plotted from the onset of the scan following the initial baseline to the end of the run, and error bars represent SEM. The functionally-defined cluster corresponding to each time course is shown in orange, and represents a 5 mm radius around the peak of clusters defined in the main effect of task for non-rating runs. At right, the time course from the left primary somatosensory cortex is presented; note that significant activation in this region is restricted to the tense pain site condition, and is not sustained into the following rest period. See Table 2 for brain region abbreviations.

FIG. 6: Brain activation associated with pain ratings. During the tense pain site period, the level of reported pain correlated significantly with the level of activation in the dorsal ACC (top panel). During the sustained pain period, reported pain correlated significantly with activation in the right anterior insula (bottom panel). The functionally-defined cluster from continuous-rating runs is shown in orange. In each plot, the y-axis shows BOLD % change (compared to the initial rest period) while the x-axis shows the average change in VAS pain rating, compared to initial rest, reported by each patient. Linear trendlines are plotted in black on each graph. Correlations were performed post hoc using data from a 5 mm radius of the peak of functionally-defined ROIs from the main effect of task for continuous-rating runs, and remained highly significant following a Bonferroni correction for multiple comparisons (ACC, p<0.0006; insula, p<0.0003; p-values two-tailed).

Table 1: Patient demographics. The gender, diagnosis and medication utilization of the 24 patients is presented. Patients were not withdrawn from ongoing medication prior to scanning for ethical considerations. Abbreviations: CBP=chronic back pain, CRPS=chronic regional pain syndrome, NSAID=non-steroidal anti-inflammatory drug. Some patients utilized multiple medication classes at the time of scanning

Table 2: Brain regions associated with tensing the chronic pain site. Functionally-defined regions of interest (ROIs) were extracted from a whole-brain GLM t-contrast between the tense pain site period and the initial rest period, in the presence of continuous ratings. Data from these ROIs was subsequently extracted from non-rating runs measured independently and tested post hoc. For each region defined at left, the peak voxel in Talairach space is provided in the second column. The FDR-corrected spatial extent (k) of each ROI is provided in mm³ The result of post hoc t-tests of the average brain activation during the tense pain site period, compared to the initial rest period, are shown for both continuous-rating and non-rating runs. Note that all ROIs are significant for both types of run. At right, ROIs demonstrating sustained brain activation during the rest period following the tense pain period are marked with a**. See fMRI findings for details. Abbreviations: L=left, R=right, aINS=anterior insula, medINS=medial insula, pINS=posterior insula, pTHA=posterior thalamus, aTHA=anterior thalamus, dACC=dorsal ACC, DLPFC=dorsolateral prefrontal cortex, OFC=orbitofrontal cortex, SI=primary somatosensory cortex, SII=secondary somatosensory cortex.

### DETAILED DESCRIPTION OF THE INVENTION

The present invention extends the understanding of the brain mechanisms of chronic pain by asking patients to elevate their pain severity through tensing the muscles of their pain site during fMRI scanning Areas within the pain matrix are activated when patients increase pain, and both reported pain and the temporal activation pattern of these brain regions are sustained following the termination of the tensing task, simulating patients' experience in daily life. Identifying regions where activation time courses mimic a patient's pain report provides a new means of localizing chronic pain mechanisms within the brain. Functional magnetic resonance imaging (fMRI) data using a novel task that engages patients' own chronic pain experience is presented. Methods of using these data to diagnose and treat chronic pain are disclosed.

In some aspects the present invention identifies a network of brain regions associated with the experience of elevated pain in chronic pain patients. In some aspects the identification occurs during a task engaging the painful region. In some aspects the identification occurs during sustained elevation of pain in the absence of any overt task. In some aspects the identification occurs during sustained elevation of pain in which occurs after an overt task engaging the painful region. In some aspects the overt task is flexing a muscle. In some aspects the overt task is a movement. In some aspects the overt task it the adoption of a posture or position. In some aspects the overt task comprises manipulation of the patients body by another individual.

In some aspects of the invention patients induce elevated pain levels by tensing their pain site. In some aspects this induction results in significant brain activation is observed in regions within the pain matrix.

In some aspects the significant brain activation includes the thalamus, insular, cingulate and somatosensory cortices, and in OFC and DLPFC. One skilled in the art will recognize that the present methods allow for the identification of multiple brain areas or combinations of these areas.

In some aspects the relationship between the activation detected in the brain and a chronic pain state is supported by the high degree of spatial similarity of activation observed during two different tasks—when patients are or are not providing continuous ratings of their pain—and by significant correlations between the magnitude of brain activation and a patient's reported pain experience. In some aspects, in a subset of brain regions, the activation observed is sustained long after patients have ceased physically manipulating their pain site, but while their pain experience remains elevated. In some aspects the regions where activation time courses mimic a patient's report of their ongoing pain represent the neural substrate mediating tonic levels of elevated chronic pain as distinct from pain elicited acutely or in association with a stimulus or task.

In some aspects the use of an externally administered nociceptive stimulus is not be necessary for modulation and examination of activation in brain areas thought to be involved in chronic pain. In some aspects of the present invention, the majority of regions demonstrating pain-related brain activity fall within those identified by the meta-analysis, including the primary and secondary somatosensory cortices, cingulate and insular cortices, multiple thalamic regions, basal ganglia, and prefrontal cortex. Without being bound by theory, activity in these regions has been proposed to underlie visceral pain processing (Moisset et al., 2009) and deactivation has been reported during the experience of placebo analgesia (Wager et al., 2004). Thus, in some aspects the present invention demonstrates that physical control over endogenous pain activates a similar set of regions to those activated by experimentally-induced pain in healthy controls. This provides one approach to resolving the difficulty raised by Apkarian et al (2005), where employing experimentally-induced pain stimuli confounds the subsequent dissociation of peripheral from central processes.

In some aspects the present invention is more closely related to measuring spontaneous fluctuations in chronic pain than approaches known in the art. In some aspects, the present invention additionally allows measurement of changes in pain both during a task and independent of one, and both associated with continuous ratings, and independent of ratings. Further, in some aspects, the level of endogenous chronic pain is overtly manipulated, allowing chronic pain to be investigated in patients who do not have spontaneous fluctuations in their pain on the timescale of the BOLD signal (patients whose pain is not fluctuating every few minutes).

In some aspects a sensitive test for a potential central pattern of neural activation correlated with chronic pain is whether this activation has a time course that is similar to the time course of the chronic pain experience, particularly over varying task conditions where pain level is maintained but other task demands vary. In some aspects of the invention brain regions that show a tonically elevated activation when pain remains elevated, in the presence or absence of the subject engaging in a task producing an overt peripheral nociceptive signal (muscle tensing to produce pain). In some aspects of the invention sustained BOLD activation is apparent for up to two minutes following the end of any overt task in several brain regions, including somatosensory, cingulate and anterior insular cortices, though the absolute level of BOLD activation decreases from the initial peak. In some aspects of the invention a sustained temporal pattern is unique to these areas. In most regions of the brain pain-specific activation returns to baseline within several seconds following the end of the tense condition. In some aspects, this pattern is present either when patients do or do not make continuous pain ratings, suggesting, that this activation cannot be accounted for by elements not related to pain, such as motor, other cognitive, or instructional elements of the task design. The presence of sustained activation in the absence of continuous ratings supports a role in mediating pain perception, not just pain evaluation or rating.

In some aspects the involvement of the network in mediating chronic pain is further supported by the presence of significant correlations between a patient's brain activation and their pain ratings. In the dorsal ACC a positive linear relationship is established between a patient's brain activation and their pain during the tense period. In some aspects, of all the regions examined, only the right anterior insula demonstrates the unique property of exhibiting sustained activation that is linearly correlated with pain ratings during the sustained pain phase in the absence of a stimulus or task. In some aspects this right anterior insula cluster is analogous to that referred to as right rostral anterior insula in a recent report by Schweinhardt et al, where activity in this region was proposed to encode clinical rather than experimental pain (Schweinhardt et al., 2006).

In some aspects of the invention in the absence of any active manipulation of their pain site, pain patients whose right anterior insula activity remains elevated report the highest sustained pain. Without being bound by theory, this activity could reflect maladaptive processes in chronic pain, as the anterior insula bilaterally has been associated with the negative affective elements of an experience, including mediating disgust during pain (Phillips et al., 1997) and catastrophizing in fibromyalgia (Gravely et al., 2004). However, this region is also thought to be broadly involved in the integration of physiological signals, or interoception (Craig, 2002). A complex relationship between prefrontal, insular, and descending pain modulatory systems appears important in mediating attentional, contextual, or emotional aspects of pain perception, and interregional correlations between these areas during pain have been reported in both healthy controls(Lorenz et al., 2002) and CBP patients(Baliki et al., 2006). Some aspects of the present invention add further prominence to a role for the insula, and the right anterior insula specifically, in mediating chronic pain.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

US 2005-0283053 A1, US 2011-0015539 A1, US 2009-0318794 A1, US 2009-0179642 A1, and US 2009-0163982 A1 are incorporated by reference.

### EXAMPLES

### Example 1

### Subjects

Twenty-four chronic pain patients (15 men and 9 women, mean age of 46 years, age range 32-62 years) were recruited from the surrounding community All patients met IASP-defined criteria for chronic pain, with diagnoses confirmed by physician; the mean duration of illness was 10 years±8. Patients had no other psychiatric or neurologic disorders including depression (mean Beck Depression Inventory, BDI=11±7), and had no contraindications to MRI. Patients had a diverse range of primary diagnoses, including both neuropathic and non-neuropathic pain conditions (see Table 1). The most common diagnosis was chronic back pain (n=13 patients). Patients were not withdrawn from ongoing medication for ethical considerations, and most patients were receiving medication at the time of scanning, with opioidergic medications being the most common (n=15 patients; see Table 1). Written informed consent was obtained in all cases, and all procedures employed were approved by Institutional Review Board. Patients were carefully monitored for potential adverse events, though none were reported.

TABLE 1
Patient Demographics

| | |
|---|---|
| Gender | 15 men |
| | 9 women |
| Diagnosis | CBP (n = 13) |
| | Peripheral Neuropathy (n = 5) |
| | Arthritis (n = 2) |
| | CRPS (n = 3) |
| | Fibromyalgia (n = 1) |
| Pain medication | Opioidergic (n = 15) |
| | Anti-depressant (n = 4) |
| | Muscle relaxant (n = 3) |
| | NSAID (n = 3) |

### Task Design and Behavioral Data Acquisition

Patients were instructed by computer-presented prompts to deliberately engage their pain symptoms during fMRI scanning The task consisted of three periods: 1) Rest, 2) Tense, 3) Sustained Pain. During the rest period (1 min) patients were instructed to relax and avoid performing any physical manipulation of their pain site. During the Tense period (1 min) patients received written instructions for increasing their pain by tensing the muscles surrounding their chronic pain site, producing an analog of the pain symptoms experienced in patients' daily lives during daily activities. During the Sustained Pain period (2 min) subjects were instructed to relax, as they had during the Rest condition, while pain symptoms continued in the absence of an overt task, producing an analog of the elevated pain symptoms that patients often endure in daily life even when they are not performing overt tasks. Patients received instructions via MRI-compatible goggles (Nordic NeuroLab, Bergen, Norway).

Runs were divided into two types: continuous-rating runs and non-rating runs. During continuous-rating runs, subjects provided continuous ratings of their current pain level using an on-screen, ten point visual analog scale (0-10 VAS; 0=no pain, 10=worst pain imaginable) using a two-button up/down controller in the right hand. Subjects were reminded every 10 s to keep rating. The continuous-rating task extended across all task periods. During non-rating runs, patients underwent the same task and saw the same graphical displays, but did not provide ratings or manipulate the two-button controller. Patients completed a minimum of 6 runs over 3 scanning sessions (mean=8 runs).

Prior to scanning, patients provided a baseline assessment of their chronic pain state on that day by completing the McGill Pain Questionnaire [MPQ (Melzack and Torgerson, 1971)]. Patients also practiced tensing their pain site and using the rating device while avoiding head motion. During scanning, patients' heads were immobilized in a full-head, custom close-fitting thermoplastic head mold, which holds the head in a precise and stable position and allows reliable repositioning of the patient across scan sessions, and was well-tolerated by patients. fMRI Imaging and Analysis

Patients received anatomical MRI scans and a series of functional MRI scans (see FIG. 1).

Whole-brain echo-planar fMRI volume data (TR=2000 ms, TE=30 ms, FA=90, FOV=21 cm, 28 slices, 64×64 matrix) were collected on a 3.0 Tesla General Electric Signa scanner at the Omneuron 3T MRI Research Center. High resolution anatomical T1-SPGR scans and 28-slice axial anatomical scans (coplanar to functional scans) were also collected for normalization and coregistration purposes, and all data collected was spatially coregistered to the first run of the first scanning session. Offline analyses were performed using BrainVoyager software (Brain Innovation, Maastricht, Netherlands). Data were 3D motion-corrected, spatially smoothed with a 3-mm Gaussian kernel, bandpass-filtered (⅕- 1/120 sec), and transformed into standard

Talairach coordinates (Talairach and Tournoux, 1988). Runs containing within-run head motion of greater than 1mm or 1 degree of rotation were excluded from subsequent analysis.

A general linear model (GLM) was constructed including each task regressor of interest, with six motion correction parameters entered into the model as nuisance regressors. Group data were analyzed using random effects analyses corrected for multiple comparisons using the false discovery rate (FDR (Genovese et al., 2002)), with all reported volumetric activations showing FDR p<0.05. The main effect of task was assessed by performing a whole-brain t contrast between the increase pain and initial rest condition, excluding an initial 20 second baseline period. GLM beta values (normalized to percent change) were extracted from BrainVoyager and analyzed post-hoc using SPSS software (version 13.0; SPSS Inc, Chicago, Ill.). Functionally-defined ROIs from clusters demonstrating a significant effect of task (after correction for multiple comparisons) were created using the main effect contrast during the continuous-rating runs. Activations from these ROIs were then assessed post-hoc using independent data from the non-rating runs, and converted to BOLD percent signal change values vs. the average of the initial rest period. The extraction of BOLD time course data from non-rating runs was restricted to voxels within a 5 mm radius of the peak voxel in clusters meeting FDR-corrected significance for the main effect of task. ROIs demonstrating sustained pain activation were defined as those where BOLD percent change, averaged over the final two-minute rest period following the end of the tensing period, was significantly greater than the initial rest period (t-test). The change in brain activation in functionally-defined ROIs from continuous-rating runs (activation during tense or sustained pain period vs. initial rest) was similarly restricted to a 5 mm radius around a cluster's peak voxel. BOLD percent change was compared with the patient's change in pain ratings (VAS ratings comparing same periods, computed by subtracting the average rating during the initial rest period from the average rating during the tense or sustained pain period). Correlations were computed using SPSS, and corrected for multiple comparisons using a post-hoc Bonferroni correction, dividing the desired alpha (0.05) by the number of tests performed (i.e., number of ROIs), deeming ROIs meeting this threshold as showing significant correlation between ROI activation and change in pain. Behavioral Findings

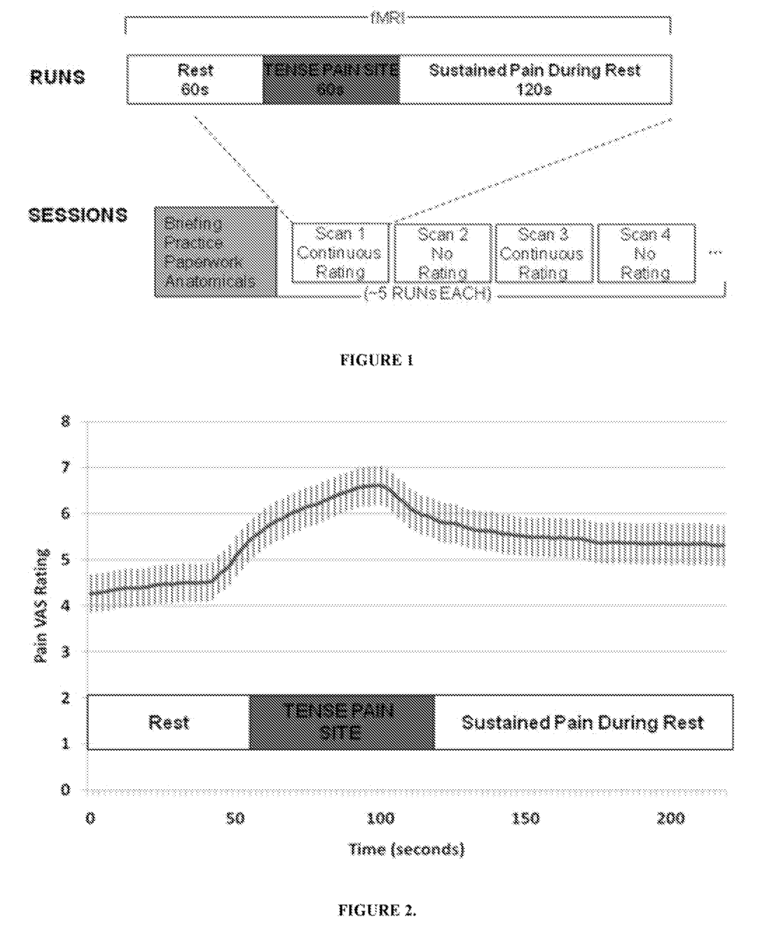

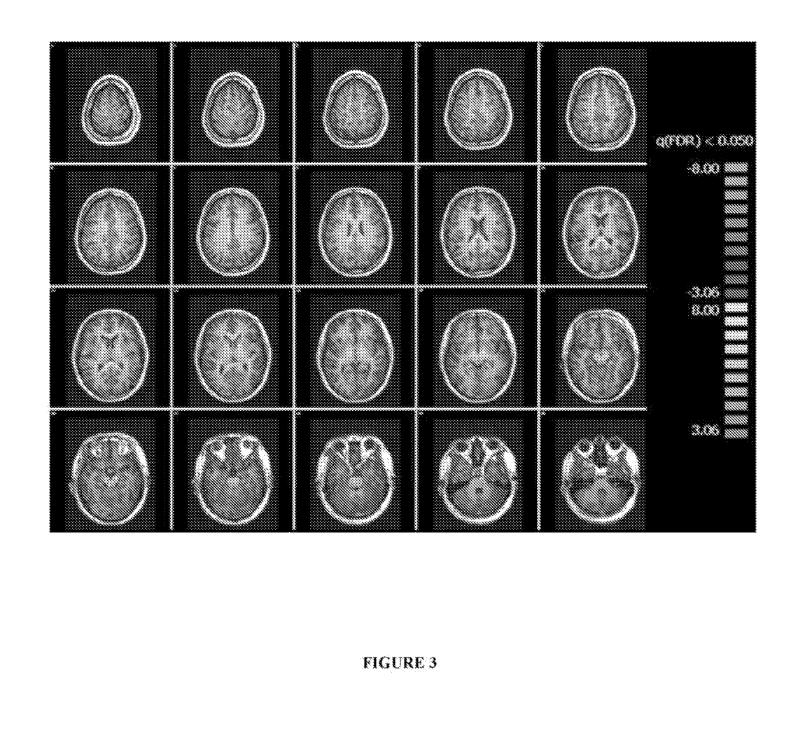

Prior to scanning patients completed a McGill Pain Questionnaire (MPQ) to assess their basal chronic pain state. Patients reported an average total pain rating of 11±10 (mean ±standard deviation), and an average MPQ VAS rating of 4.8±2. Immediately prior to each fMRI scanning run, patients reported an average of 4.6±2 on the online VAS pain intensity scale. Patients were able to increase their pain by tensing the muscles of their chronic pain site, reporting significantly greater pain ratings averaged over the entire tense period (VAS=6.0±3; paired-t vs. rest, t=10.7, one-tailed p=1×10⁻¹⁰). During the sustained pain period, patients continued to report significantly elevated pain compared to the initial rest period (VAS=5.6±2; paired-t vs. rest, t=5.2, one-tailed p=1×10⁻⁵). The time course of the average continuous VAS pain ratings provided across all patients is shown in FIG. 2.

fMRI Findings

Tensing the chronic pain site was associated with significant and widespread increases in brain activation. A whole-brain GLM t-contrast between the tense pain site period and the initial rest period revealed activation in multiple brain regions after correction for multiple comparisons (FIG. 3), including bilateral primary (SI) and secondary (SII) somatosensory cortices, right anterior and posterior thalamus, bilateral insular cortex, dorsal anterior cingulate cortex (ACC), posterior cingulate cortex (PCC), left dorsolateral prefrontal cortex (DLPFC), and right orbitofrontal cortex (OFC). For all regions meeting FDR-correction for multiple comparisons, BOLD % change values were extracted and the statistical significance of the increase pain vs. rest contrast was confirmed using post-hoc t -tests (Table 2).

TABLE 2
Functionally-defined ROIs

| | TAL | | Continuous Rating | | Non-Rating | | Sustained |
|---|---|---|---|---|---|---|---|
| REGION | x y z | k (mm³) | t | p | t | p | Activation |
| dACC | 3 −4 43 | 2421 | 6.3 | 0.000002 | 4.4 | 0.0003 | ** |
| R medINS | 48 11 7 | 3716 | 5.8 | 0.000006 | 4.0 | 0.0008 | |
| L pINS | −54 −4 4 | 2699 | 5.2 | 0.00003 | 4.4 | 0.0003 | |
| L medINS | −45 13 5 | 4563 | 5.1 | 0.00003 | 6.1 | 0.000008 | |
| R aINS | 45 23 1 | 639 | 4.8 | 0.00008 | 3.4 | 0.003 | ** |
| R OFC | 33 35 −12 | 306 | 4.8 | 0.00008 | 2.5 | 0.02 | |
| R pTHA | 4 −25 7 | 232 | 4.8 | 0.00009 | 3.6 | 0.002 | |
| R pINS | 30 −1 9 | 1311 | 4.6 | 0.0001 | 3.6 | 0.002 | |
| L SI | −51 −47 34 | 933 | 4.4 | 0.0002 | 3.4 | 0.003 | |
| L DLPFC | −33 35 27 | 1096 | 4.3 | 0.0002 | 3.6 | 0.003 | |
| R SI | 54 −34 34 | 1426 | 4.3 | 0.0003 | 3.5 | 0.002 | ** |
| L SII | −54 −7 16 | 1381 | 4.2 | 0.0003 | 3.5 | 0.002 | ** |
| R SII | 57 −25 18 | 1910 | 4.2 | 0.0004 | 3.5 | 0.002 | |
| R aTHA | 0 −10 10 | 111 | 4.0 | 0.0005 | 3.0 | 0.007 | |
| PCC | −3 −55 28 | 854 | 4.0 | 0.0006 | 3.4 | 0.003 | |
| L aINS | −43 23 1 | 217 | 3.7 | 0.0007 | 3.6 | 0.002 | |

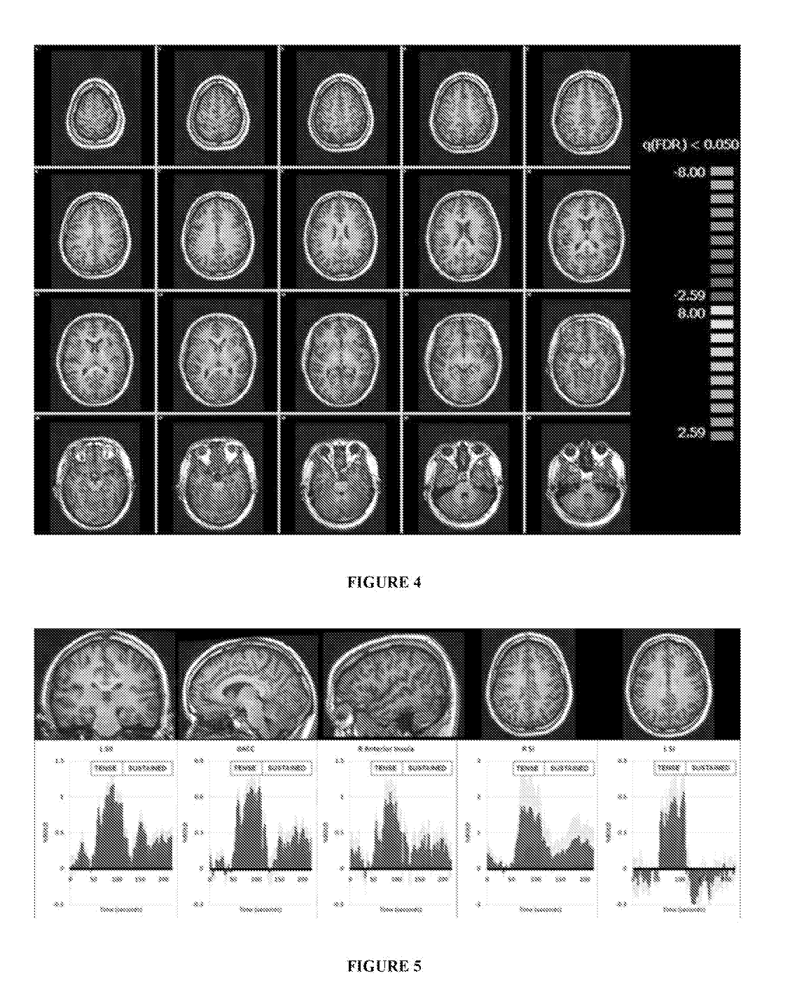

Brain activation from ROIs defined using the continuous-rating task were compared with activation independently measured during the corresponding non-rating task to assess reproducibility across tasks, and to ensure that the observed activation was associated with pain, not confounded by the motor or cognitive aspects of providing continuous pain ratings. All the ROIs meeting FDR-corrected significance during the continuous-rating task showed significant activation during the non-rating task (Table 2). Similarly, maps of brain activation were highly similar during the continuous-rating and non-rating tasks (FIG. 4).

To determine whether activation in each activated brain region was sustained during the sustained pain period, or whether it ceased with the completion of the tensing task, time courses of activation from each ROI were assessed over the duration of the experiment. This identified brain regions with sustained activation, mirroring the patients' pain experience rather than their behavioral tensing. Four of the activated ROIs were defined as showing sustained activation associated with chronic pain, as demonstrated by BOLD percent change during the sustained pain period that was significantly greater than rest: right primary somatosensory cortex (sustained pain vs. baseline, t=8.9, two-tailed p=6×10⁻¹⁴), left secondary somatosensory cortex (t=8.6, p=3×10⁻¹³), right anterior insula (t=5.3, p=1×10⁻⁶), and dorsal ACC (t=5.0, p=3×10⁻⁶). These four regions showed significant sustained activation during the non-rating tasks (FIG. 5). Notably, the phenomenon of sustained activation mirroring patient pain ratings was not apparent in a number of other activated brain regions, including bilateral medial and posterior insula, left primary or right secondary somatosensory cortex, right thalamus, PCC, right OFC, and left DLPFC (Table 2). The time course from the left primary somatosensory cortex provides a representative example of a brain region with significant activation associated with the active tensing period of the task, but without increased activation associated with a sustained elevation of pain.

Relationship between Brain Activation and Pain

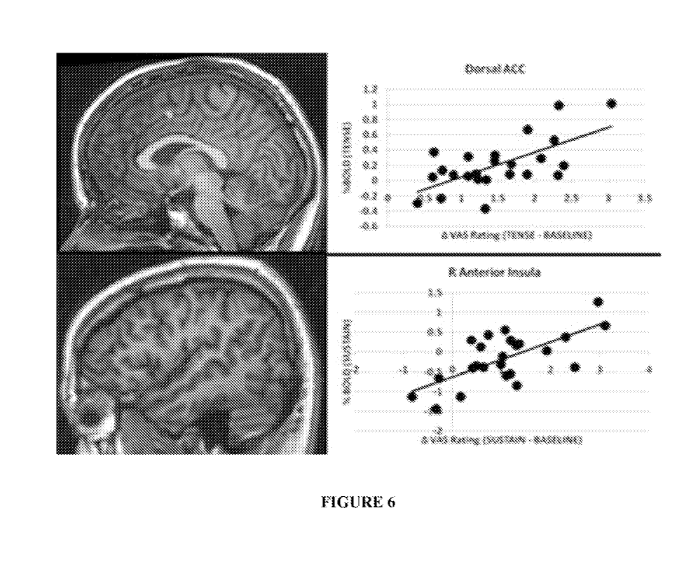

The relationship between brain activation and pain was assessed using post-hoc correlation analyses of data from continuous-rating runs. The average BOLD % change during the tense period or sustain period vs. rest was compared with the average change in pain from the same time points. A significant correlation was observed in one of the sixteen ROIs tested during the tensing period following Bonferroni correction for multiple comparisons, the dorsal ACC (r=0.65, t=4.0, p<0.0006 two-tailed). During the sustained pain period a significant positive correlation was observed in the right anterior insula, again following a post-hoc correction for multiple comparisons (r=0.68, t=4.3, p<0.0003 two-tailed). Scatter-plots of significant correlations and the functional clusters from which they were identified are shown in FIG. 6. These correlations are not the result of multiple comparisons/observation bias, and have been corrected for these effects (Poldrack and Mumford, 2009).

What is claimed is:

1. A method comprising creating a database of fMRI patterns wherein the database comprises fMRI patterns obtained from individuals who suffer from chronic pain and wherein said individuals trigger said chronic pain by an overt act prior to or during the fMRI scan.

2. The method of claim 1 wherein the overt act is flexing muscles surrounding the site of the chronic pain.

3. A method comprising statistically comparing the database of claim 1 to the fMRI pattern of an individual suspected of having chronic pain to determine whether the individual exhibits and fMRI pattern indicative of chronic pain.

4. A method comprising determining whether a patient should be reimbursed for the treatment of chronic pain based upon the results of the method of claim 2.

5. A method comprising determining whether a patient should be treated for chronic pain based upon the results of the method of claim 2.

6. A method comprising determining whether a patient should qualify for insurance coverage for the treatment of chronic pain based upon the results of the method of claim 2.
